(19) United States
(12) Patent Application Publication
(10) Pub. No.: US 2006/0064642 A1
(43) Pub. Date: Mar. 23, 2006

(54) Seamless presentation integrator

(75) Inventor: Srikanth Balasubramaniam Iyer, Bangalore (IN)

Correspondence Address: Ashok Tankha;LIPTON WEINBERGER & HUSICK, 201 North Jackson Street, P.O. Box 934, Media, PA, 19063, US

(73) Assignee: Edurite Technologies Pvt. Ltd., Bangalore (IN)

(21) Appl. No.: 10/947,491

(22) Filed: Sep. 22, 2004

(51) Int. Cl. G06F 17/00; G06F 17/21

(52) U.S. Cl. 715/730; 715/500.1; 715/731; 715/513

(57) ABSTRACT

A computer-implemented system and method of creating a presentation is provided. The method provides an off-line presentation application to allow the addition of multimedia objects from a central repository comprising multimedia objects. This method also provides instantaneous correlation of multimedia objects for the text inputs of the user, and for embedding the selected multimedia objects to presentation slides. The multimedia objects can either be animations, movies, or diagrams. This method also allows a user to search the repositories for multimedia objects using keywords. The local repository can be updated using an update manager with newly available multimedia objects from the central repository. This system also provides means for creating and continuously playing multimedia presentation.

### BACKGROUND OF THE INVENTION

This invention, in general, relates to creating presentation slides and specifically relates to a computer based system for creating presentation slides using multimedia objects.

Computer based training or teaching herein refers to a computer-aided method of training or teaching using presentation slides in a computer. A motivation for the use of computers in schools and universities is to make learning an enjoyable experience. The driving force for the use of computerized systems in companies is to reduce the cost incurred in training new employees, or the retraining of employees. Computer-aided methods and tools are also used for creating effective and appealing presentations for business development.

Computer based presentation creation systems have made major technical advances in recent years. A current approach is directed to a plurality of display stations that serve as terminals and interact with a mainframe computer to display educational materials and allow the user to interact with the mainframe via an input device, such as a keyboard.

Another current approach is directed to a system, method and article of manufacture of rule-based expert training for building success in a business endeavor, wherein the system simulates a real-world environment and provides feedback to the user.

Another current approach is directed to a computer based training using digitally compressed and streamed multimedia presentations over the internet using computer based training (CBT). In this method the user is connected via the internet to a server and the server acts as a host for database storage. The selected files are copied from video and audio cue points, noted to coincide with the presentation of each slide.

Another current approach is related to a computer based educational system for teachers and students. The server computer includes a lesson database for storing lesson materials where the lesson material includes text, image, video, audio and program files. This system also includes a lesson builder for the teacher or other user to search lesson material database and retrieve the same.

Another current approach is related to a network delivering computer based training and instructional materials in multimedia format. This method includes a software module, which reads and interprets the lesson file along with the multimedia contents to produce a multimedia training application. The lessons available to the students are organized into a menu and displayed to the user.

The above approaches for creating presentations focus on computer based presentation methods. These are essentially passive processes. There is an unsatisfied need in the market place for creating presentations quickly and effectively using multimedia objects wherein the multimedia objects are instantaneously selected and seamlessly integrated to create a continuous flowing presentation.

### SUMMARY OF THE INVENTION

This invention discloses a method of instantaneous incorporation of multimedia objects correlating with the text inputs of the user, and also a method of creating continuously playing multimedia presentation.

This invention also discloses a system for incorporating multimedia objects into presentation slides for business development in a corporate environment.

This invention also discloses a software tool comprising a local repository of multimedia objects which can be updated using the internet from the central repository of multimedia objects at the central location.

This invention also discloses a method of either searching or automatically inserting objects from a multimedia object repository comprising videos, animations, and diagrams to presentation slides.

Another object of the invention is to assist the teaching community in adding multimedia objects to their teaching slides, thus empowering students with multimedia learning objects and creating a rich classroom experience.

The computerized system of this invention instantaneously correlates text inputs of the user to multimedia objects in real-time and presents a choice menu of relevant multimedia objects to the user. The selected multimedia objects available on the internet server can be embedded onto a presentation slide using this method. This system instantaneously creates an uninterrupted and continuously playing multimedia presentation.

The application of the present invention provides easy access to a central repository of multimedia objects through the internet for remote and geographically dispersed users, thus giving users an effective tool for an evolving environment.

An update manager bundled with an off-line component ensures seamless synchronization of the local repository in the desktop with the central repository on the internet server, thus delivering newer objects to users with minimal effort and less time. Animations, videos and diagrams are the three main categories of multimedia objects provided in the multimedia repositories.

The functionality of the computer-based educational system of the present invention can be advantageously realized using standard, commercially available hardware and software application programs. It is particularly useful for creating high impact business presentations. It minimizes custom programming, and reduces the operating cost of the system for the users.

Collections and search are the two options available with the seamless presentation integrator to find specific multimedia objects easily and effectively. There are other features of the local multimedia repository, such as “add new”, “modify” and “delete” that enhance additional usability of this method.

A more complete understanding of the present invention, as well as further features and advantages of the present invention, will be obtained from the following detailed description and drawings.

### BRIEF DESCRIPTION OF THE DRAWINGS

The current invention is illustrated by way of example, and not by way of limitation in the accompanying drawings, where like reference numerals refer to similar elements and in which:

FIG. 1 is a block diagram of a computer-based system for creating presentations.

FIG. 2A is the schematic illustration of the client to server communication of the present invention.

FIG. 2B is the structure of Collection.xml.

FIG. 2C is the structure of Meta.xml.

FIG. 2D is the structure of ConFIG.xml.

FIG. 3 shows a windows registry after add-in entry in the application presentation.

FIG. 4 is the representation of the menu of the seamless presentation integrator after loading the program at the user computer.

FIG. 5 is a collection view of the available multimedia collection.

FIG. 6 illustrates the method of adding animations to presentation slides.

FIG. 7 shows the method of adding videos to presentation slides.

FIG. 8A shows the method of adding images to presentation slides.

FIG. 8B illustrates the method of adding multimedia objects to presentation slides using instant correlate.

FIG. 8C illustrates the process flow diagram for adding multimedia objects to presentation slides using instant correlate.

FIG. 9 illustrates the method of searching for a multimedia object in the local repository.

FIG. 10 is the schematic representation of the search methodology for searching multimedia objects present in the local repository.

FIG. 11A illustrates the method of adding new objects to the local repository.

FIG. 11B illustrates the method of adding animations to the local repository.

FIG. 12 illustrates the method of creating a continuously playing multimedia presentation.

### DETAILED DESCRIPTION OF THE INVENTION

This invention relates to a computer based system for creating presentation slides using multimedia objects. This invention also relates to a method of incorporating multimedia objects into a presentation slide.

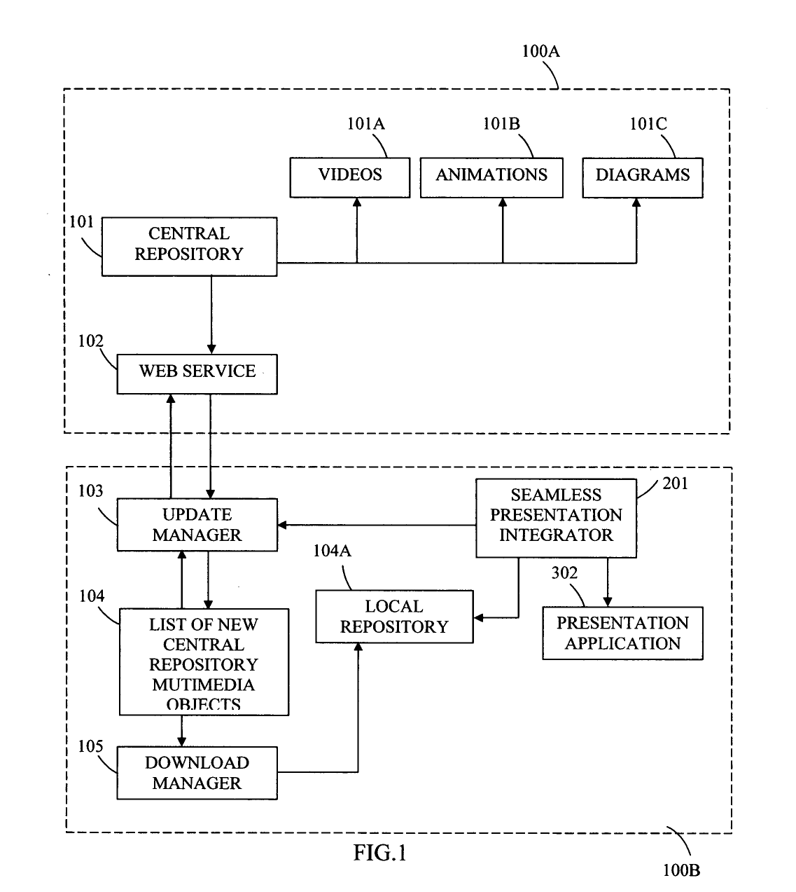

FIG. 1 illustrates a computer-based system for creating presentations. The computer-based presentation creation system includes an on-line component 100A and an off-line component 100B. The on-line component 100A includes a central repository 101 comprising videos 101A, animations 101B, and diagrams 101C hosted on a web service 102 on the internet. The off-line component 100B includes a seamless presentation integrator 201, an update manager 103, a download manager 105, a local repository 104A, and a presentation application 302 on the user computer.

The on-line component 100A provides the facility to search, view and download multimedia objects to a local repository 104A on the desktop computer of a user for remote and geographically dispersed users. The local repository 104A and the central repository 101 are synchronized during the process of presentation creation. The on-line component 100A contains a central repository 101 of all multimedia objects hosted on a web service 102 and is accessible to remote users via the internet. The central repository 101 gets updated automatically at the end of a new object production phase. A web service 102 on the on-line component 100A adds new object details to the off-line component.

The off-line component 100B allows the search and view of multimedia objects and the addition of hyperlinks to presentation slides. The hyperlinks point to the multimedia resource. The update manager 103 compares the multimedia object meta details of the local and central repositories and outputs the list of new multimedia objects 104 on the central repository 101 to download by the download manager 105. The off-line component 100B is integrated tightly with the presentation application 302 shown in FIG. 1. The presentation application 302 is a commercial software application, for example a Microsoft PowerPoint Presentation of Microsoft Inc., USA.

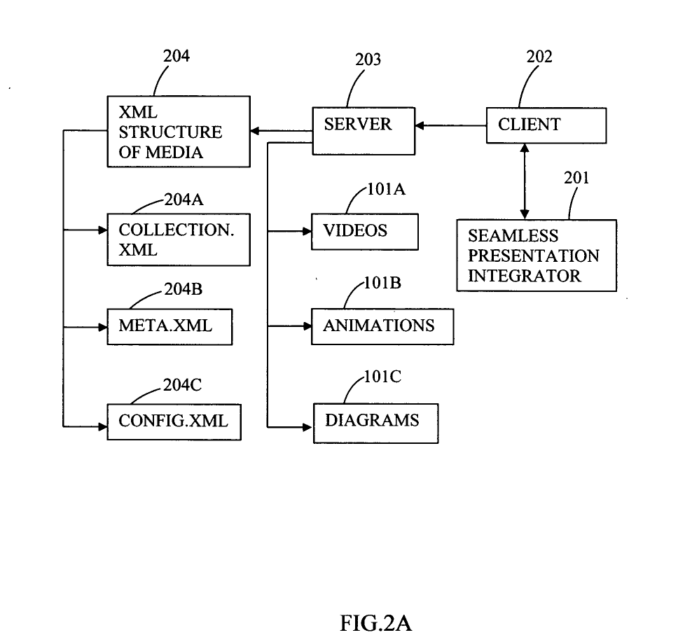

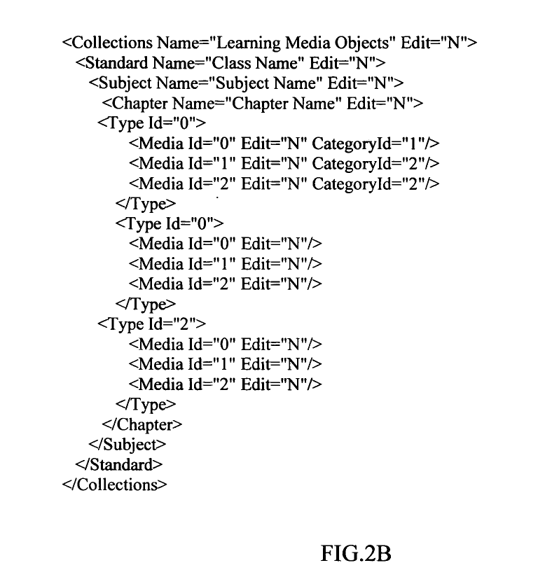

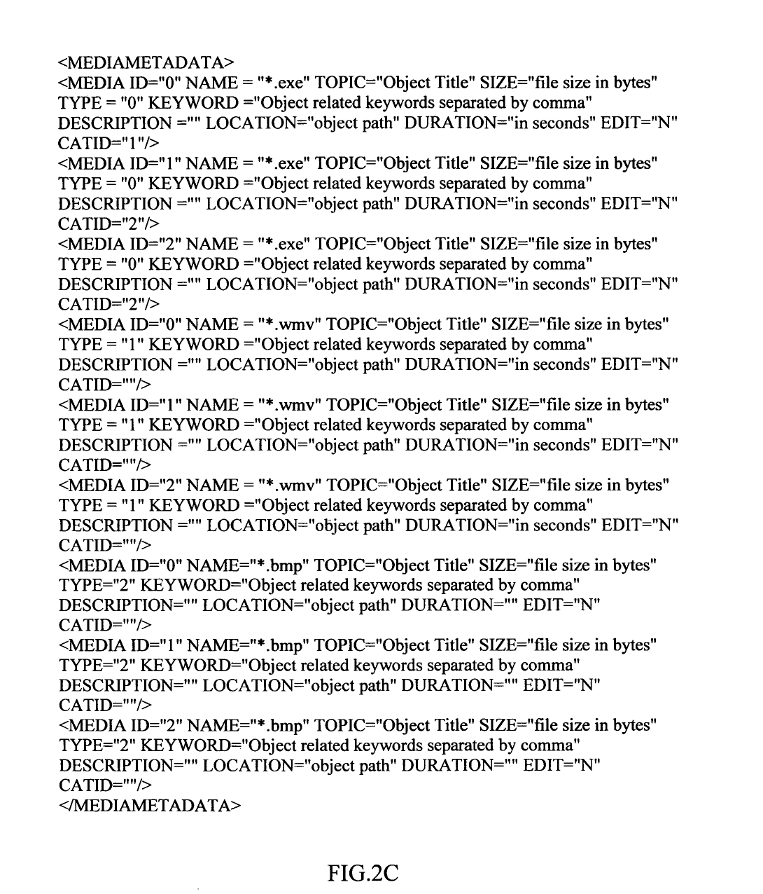

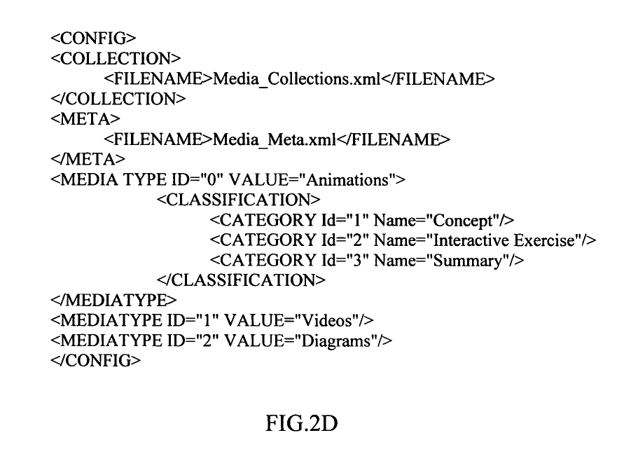

The Extensible Markup Language (XML) structures of multimedia objects 204, FIG. 2A include Collection.xml 204A, Meta.xml 204B, and ConFIG.xml 204C. They are used to store different multimedia objects. Collection.xml 204A illustrated in FIG. 2B provides an object relation to class, subject and chapter. Meta.xml 204B structure illustrated in FIG. 2C provides the Meta information of each object such as object title, file name, keywords, file size, duration and short description the object. ConFIG.xml 204C illustrated in FIG. 2D provides referential information about object types and category.

The application process starts with a menu click in the presentation application 302. The computer-based presentation creation system has two setup options, namely client 202 setup and server 203 setup, shown in FIG. 2A.

In the server 203 setup, object structure and all the multimedia objects are bundled. At installation, all the multimedia objects and object structures are copied to the user specified location. Server 203 setup requires more space to install with the space required dependent on the count of multimedia objects bundled. Server 203 setup installation makes server 203 specific necessary registry entries depending on the target operating system (OS). Server 203 setup also registers components and makes necessary registry entries depending on the presentation application 302 and target OS. The folder with the installed multimedia objects has to be shared so that client setup users can access the media objects via Transmission Control Protocol/Internet Protocol (TCP/IP).

Client 202 setup, contrary to the server 203 setup, is not bundled with the multimedia objects. Client 202 setup registers product specific components and makes necessary registry entries depending on the presentation application 302 and target OS. Client 202 setup user needs to specify the server 203 path where the object library is installed in the product preferences. This is a shared folder in the server 203 for which the client 202 setup user is given access. Client 202 setup application accesses the object structure and media objects from the server 203 folder over the local area network.

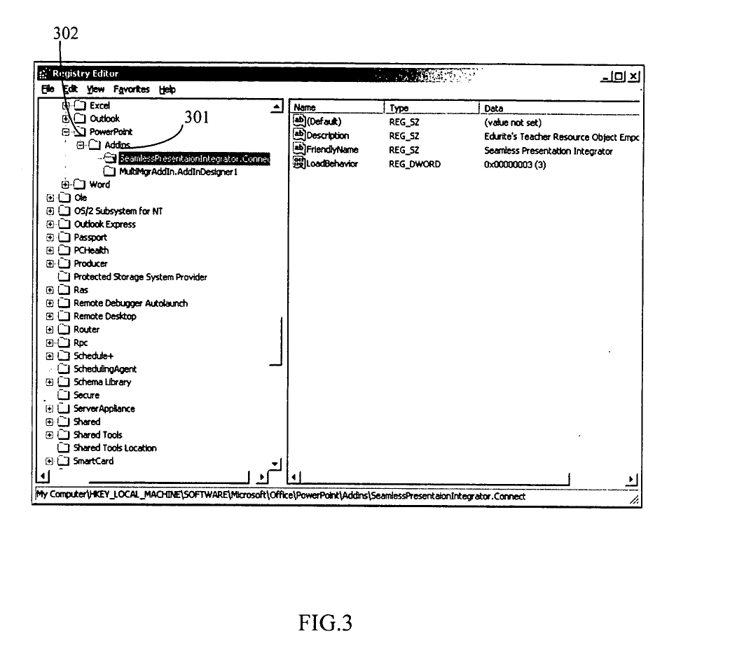

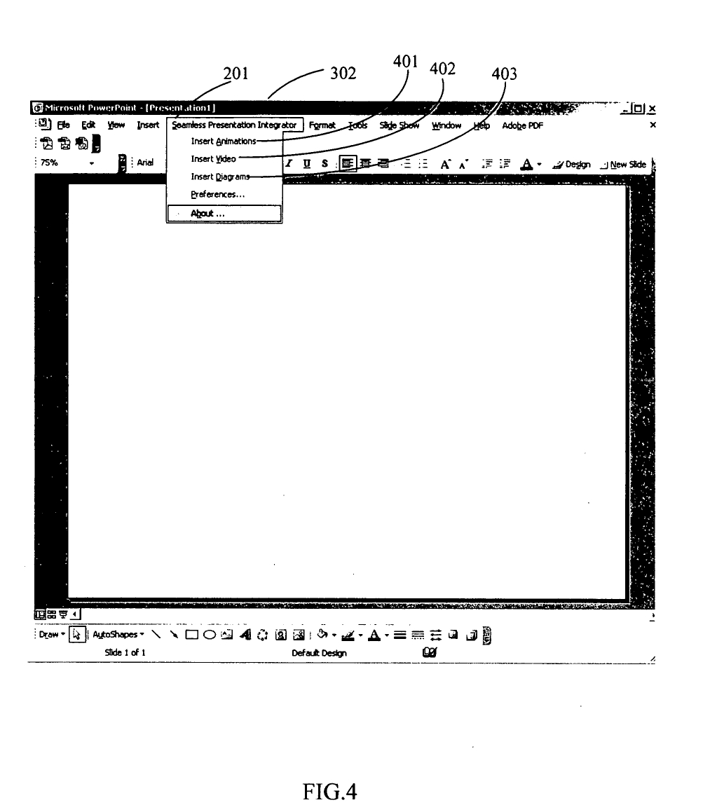

In both the setups, application-specific files are registered depending on the target operating system and a menu add-ins 301 is created in the windows registry as shown in FIG. 3. This process also crates a menu for the seamless presentation integrator 201 in the presentation application 302 as shown in FIG. 4.

The computer-based presentation creation is activated when the presentation application 302, FIG. 4 is invoked. The seamless presentation application is invoked in the operating system of the computer of the user in the following cases:
1. When the shortcut to the presentation application 302 is clicked.
2. When another application invokes the presentation application 302.
3. When the presentation application 302 is embedded in another application and a routine/module invokes its features.
   The seamless presentation integrator 201 checks if any of the preceding conditions is fulfilled and gets fully loaded only when the first condition described in item 1 above, is fulfilled.

FIG. 4 shows the menu for seamless presentation integrator 201 after the program is loaded at the presentation application 302. The user can select from a wide range of objects, which can be video 101A, an animation 101B, or diagram 101C from the central repository 101.

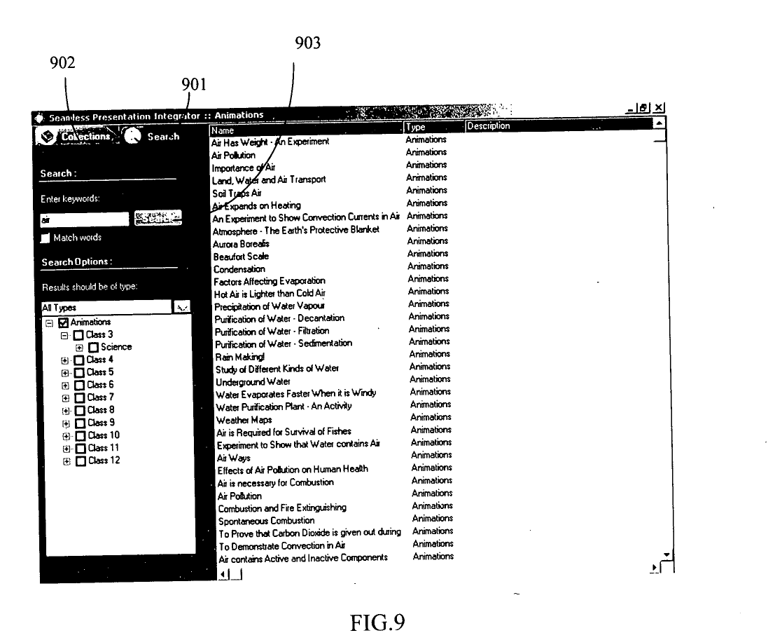

The collections 902 or search 901 shown in FIG. 9 can be used to find relevant multimedia objects and the user can add a hyperlink to a slide pointing to the multimedia resource.

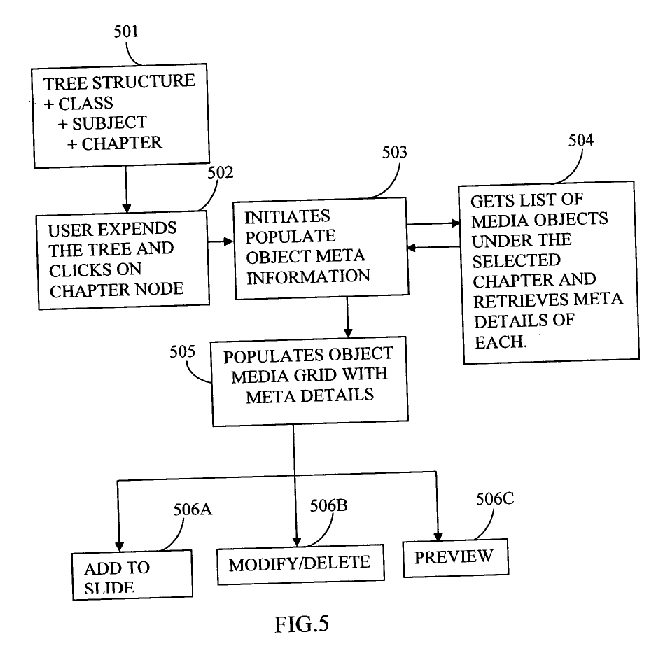

A collection view represents a repository structure of multimedia objects as shown in FIG. 5. This particular view allows users to browse through the multimedia collection to pick up relevant multimedia objects. The separate collection list for each multimedia type such as animation 101B, video 101A and diagrams 101C allows faster search of relevant multimedia object. A hierarchical tree structure 501 is loaded onto a tree view. The class is the parent node, a subject is the child node to the class, and a chapter is the child node to the subject.

If the user clicks on a class in the tree structure 501, FIG. 5, it expands the tree 502 to show a list of subjects available under the node. If the user clicks on a subject in a tree structure 501, it provides the list of chapters available under the selected subject. Clicking on the chapter node initiates and populates the object Meta information 503 of all the multimedia objects and retrieves the list of available multimedia objects under a selected chapter along with the Meta details of each object 504. The object media grid with Meta details are populated 505. The user can add 506A, modify or delete 506B, or preview 506C the resulted multimedia objects.

The user can add animations 101B to the slide by clicking on the “Insert Animation” 401 menu provided in the seamless presentation integrator 201 menu shown in FIG. 4. This opens the repository with a list of available animations 101B in the central repository 101.

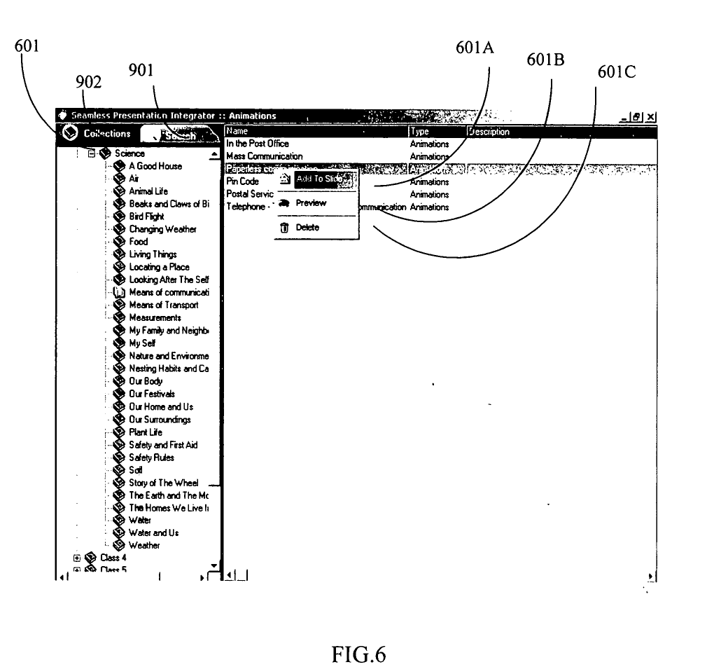

FIG. 6 illustrates the method of adding animations to presentation slides. The user can click on the content tree 601, shown on the left side of the FIG. 6 screen and select a chapter under a particular standard and subject. By clicking on any chapter name, a list of animations 101B available for that chapter is displayed on the right side of the screen as shown in FIG. 6. The user can either preview an animation 601B, FIG. 6, or add an animation to a slide 601A. The user also has the provision to delete 601C animations 101B displayed on the screen. The user can also right click on the animation name and click the “Preview” option 601B to preview an animation. The user can also double click on the animation name, or the user can right click the animation name and click “Add to Slide” 601A to add an animation to a slide.

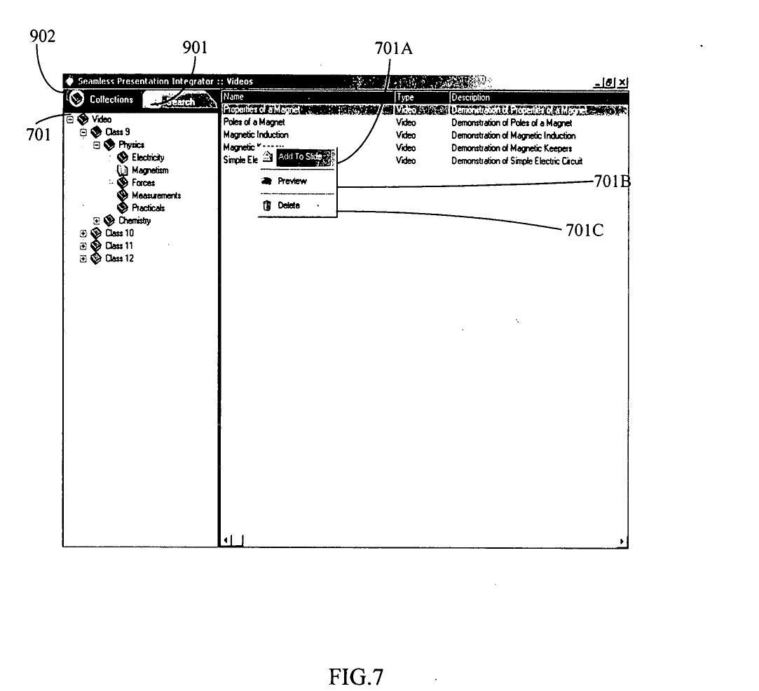

FIG. 7 shows the method of adding videos to presentation slides. The user can add video 101A to a slide, using the option “Insert Video” 402 from the seamless presentation integrator 201 menu shown in FIG. 4. This opens the repository with the list of available media as shown in FIG. 7. The user then needs to click on the video content tree 701, FIG. 7 and select a chapter under a particular standard and subject. Once the user clicks on the chapter name, a list of multimedia available for that chapter is displayed on the right side of the screen. The user can either preview 701B a video 101A or add 701B a video 101A to a slide. The user also has the provision to delete 701C a video 101A displayed on the screen. The user can also right click on the video name and click the “Preview” option 701B to preview video 101A clippings. The user can also double click on the video 101A name or right click the video 101A name and click “Add to Slide” 701A to add a video to a slide.

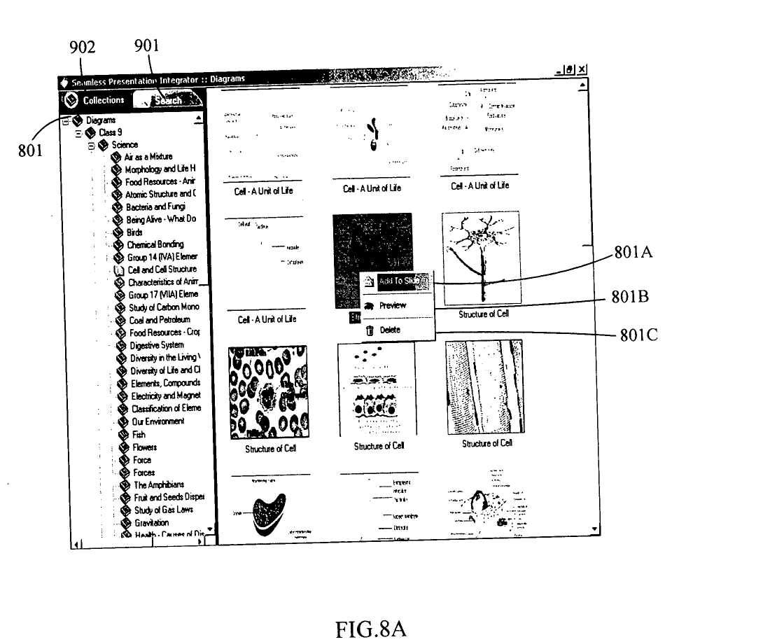

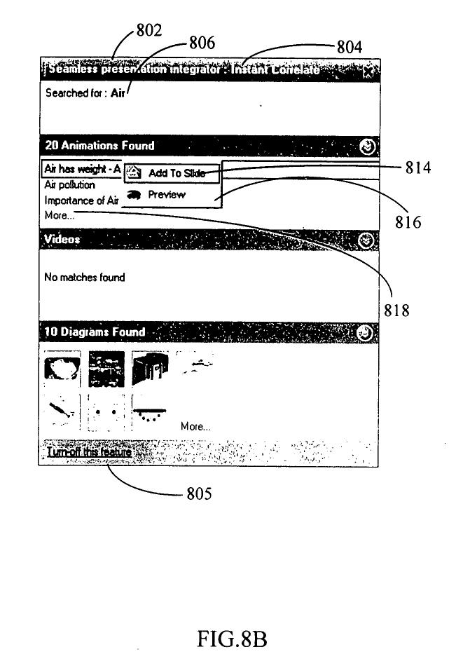

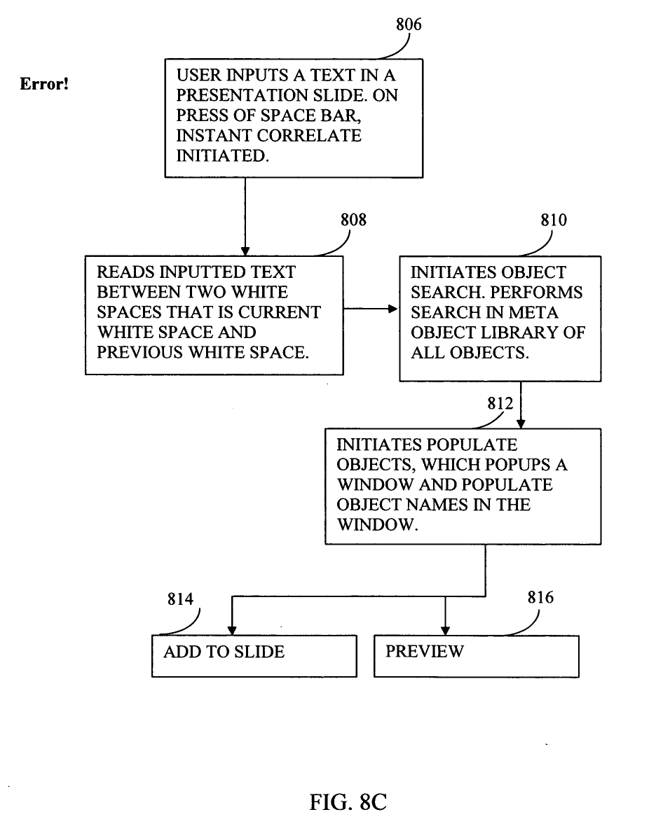

FIG. 8A shows the method of adding images to presentation slides. The user can also add diagrams 101C to a slide by clicking on “Insert Diagrams” 403 from the seamless presentation integrator 201 menu shown in FIG. 4. This opens the repository with the list of diagrams as shown in FIG. 8A. The user then needs to click on the diagram content tree 801, FIG. 8A on the left side of the screen and choose a chapter under a particular standard and subject. Once the user clicks on the chapter name, a list of images available for that chapter is displayed on the right side of the screen. The user can either preview 801B a diagram 101C or add 801A a diagram 101C to a slide. The user also has the provision to delete 801C a diagram 101C displayed on the screen. The user can then right click on the diagram name and click the “Preview” option 801B to preview a diagram. The user can also double click on the diagram name or the user can right click the diagram name and click “Add to Slide” 801A to add a diagram to a slide.

FIG. 8B illustrates the method of adding multimedia objects to presentation slides using instant correlate. Instant correlate 804 illustrated in FIG. 8B is a feature that correlates user text input with the product object repository and shows the matches found to the user. For the text inputted by the user in a presentation, seamless presentation integrator 201 instantly searches in the Meta object database and fires a pop-up window 802 as shown in FIG. 8B, showing the matching objects found for insertion into the slide. FIG. 8B shows the search result for “Air” using the instant correlate 804 method. This method also provides the options such as “Add To Slide” 814, or “Preview” 816 to the resulting multimedia objects. This facility gives the users a rich user-experience with minimal user intervention. Seamless presentation integrator 201 shows a list of matching multimedia objects, which enables a user to prepare multimedia rich presentations. Instant correlate 804 features can be turned off, or on, using “Turn off this feature” 805, an option that is accessible from the product preference menu.

FIG. 8C illustrates the process flow diagram for adding multimedia objects to presentation slides using instant correlate. When a user types a word to be “Searched for” at 806 and presses the space bar, seamless presentation integrator's 201 “Instant Correlate” 804 feature initializes and reads the text between the current white space and the previous white space 808, FIG. 8C and calls search-objects with the user-inputted text as a parameter. Search objects search the object Meta object library 810 and returns zero if no matches are found, or returns the list of object identifications matching the input parameter. Instant Correlate 804 reads the list of object identifications from search-objects, fires a pop-up window 802, and populates category wise object details 812. This method also provides options such as “Add To Slide”. 814 or “Preview” 816 to the resulting multimedia objects.

Instant correlate 804 is an application designed using Visual Basic (VB.net). The application is invoked by Visual Basic for Application (VBA) from the presentation application 302. The user inputted text is passed as a parameter to the “Instant Correlate” 804. A method in the application receives input text keyed by the users from a VBA, performs a search, and displays the results in the “Instant Correlate” 804.

The window showing the matches is movable and resizable. The window does not close automatically unless closed by the user. If one instance of window is open, another will not open and new values will be populated for every correlate input event.

For animation and video objects, names are populated in the window. For diagrams, thumbnails of the diagrams are populated. FIG. 8C illustrates the process flow diagram of real-time incorporation of multimedia objects correlating with the text inputs of the user. The user either can “Preview” an object 816, or can “Add (an object) to Slide” 814. The user can also right click on the object name and click on the “Preview” option to preview 816 an object. The user can also double click on the object name, or the user can right click the object name and click “Add to Slide” to add an object 814. To view more details about the objects, the user can click “More” 818 shown in FIG. 8B, which opens a bigger window that shows a detailed view of objects as illustrated in FIG. 9.

The user can search for relevant multimedia learning objects by using the search option shown in FIG. 9. The user can perform keyword searches by clicking on the “Search” tab 901 as shown in FIG. 9.

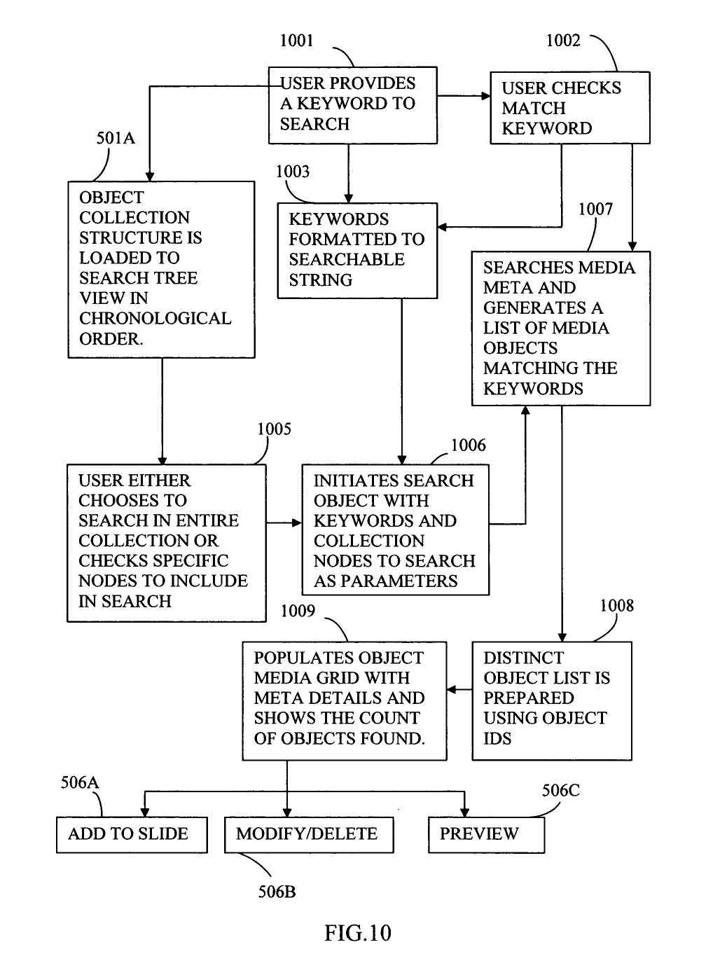

FIG. 10 provides the schematic representation of the search methodology for searching multimedia objects present in the local repository 104A. Consider the case when the instant correlate 804 is turned off. The user needs to provide a keyword 1001 and needs to click the “Search” button 903, FIG. 9 to initiate the searching process. The user can check the “match keyword” 1002 option to find an exact match for the keyword provided. The keywords are formatted to a searchable string 1003.

An advance search option loads an object collection structure to search tree node 501A in chronological order. Check-boxes provided for each tree node 501A in the search tree allows users to specify the node structure. By default, the entire tree structure is included in the search. The search process matches the user given keyword with the user specified node structure 1005.

In the both the search methods, the search is initiated using search object with keywords and collection nodes to search as parameters 1006. The search is conducted using media meta and a list of media objects matching the keywords are generated 1007. A distinct object list is prepared using object IDs 1008. The object media grid with meta details is populated and shows the count of objects found 1009. The Meta object information 1009 in the grid is populated. The user can either preview 506C the objects, or add hyperlinks to the slide. For diagrams, the user can add 506 A the selected diagram to the presentation slide.

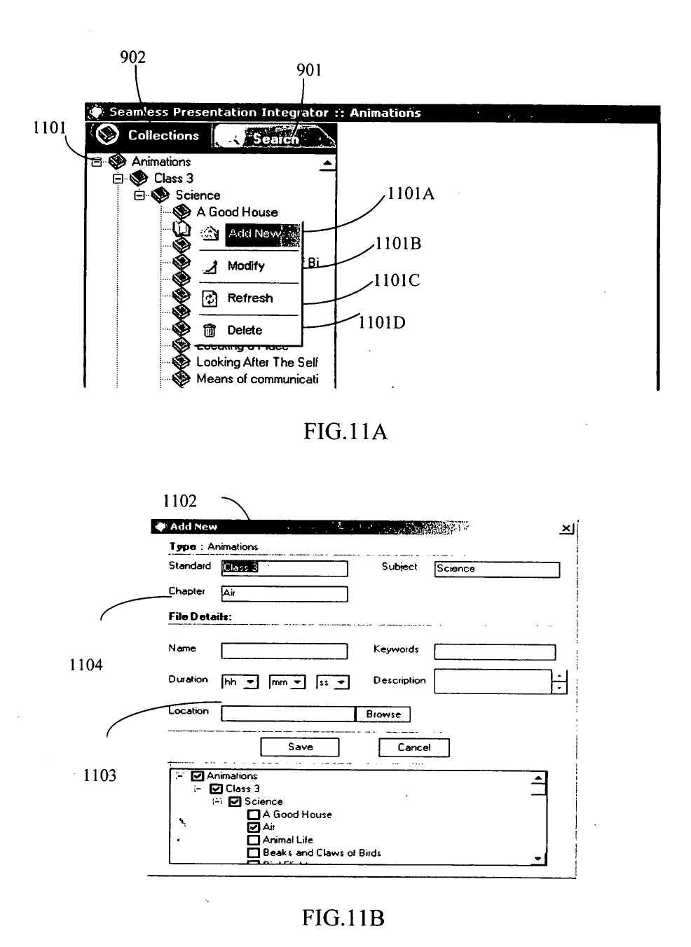

The presentation creation method of this invention provides a customization feature that allows users to add new objects to the local repository 104A. Users can right click a tree node 1101 in the collection view of FIG. 5 and click “Add New” 1101A in the context menu, and add new objects as shown in FIG. 11A. A new object is either added under the user specified node, or the node that is selected when the right click, becomes the default node.

Clicking on “Add New” menu 1101A pops a form window 1102 that accepts user inputs required for saving new objects, as illustrated in FIG. 11B. Using the checked tree view 1101 that contains the loaded existing local repository 104A structures, the user can check a specific node to which the new object is added, or the user can specify a new class, subject and chapter. The user has to provide a multimedia object location 1103 and the file details 1104 about the multimedia before saving the new multimedia object. A client 202 setup user should have write permission to the server 203 folder of the on-line repository object. The saving of new multimedia objects to the local repository 104A updates the local repository 104A structure, updates the Meta details and copies multimedia to the object local repository 104A.

The user can “Modify” 1101B or “Refresh” 1101C or “Delete” 1101D an added object as shown in FIG. 11A. The user can go to the “Modify” 1101B screen by right clicking a multimedia object from the right side grid. On confirmation, the object is deleted from the local repository 104A; the structure and Meta details of the multimedia are then updated.

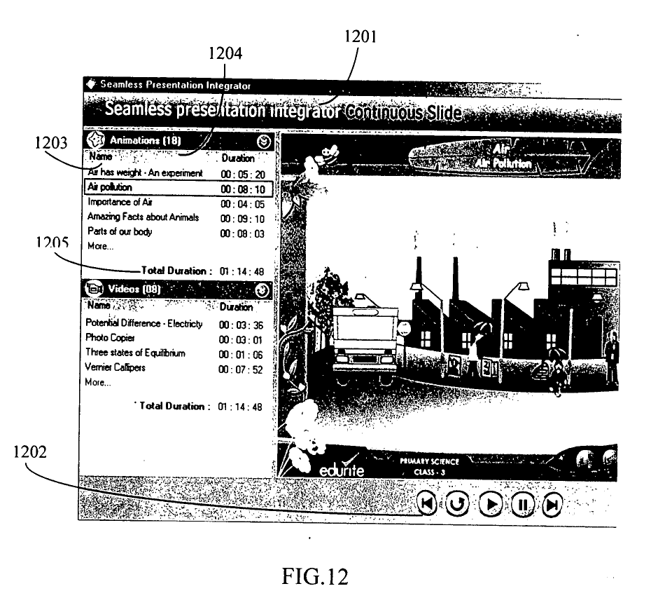

Continuous multimedia presentation is a feature that allows the user to add selected multimedia objects to a “Continuous Slide” 1201 interface and view all the selected multimedia objects in sequence one after the other as shown in FIG. 12. This feature will help the user to decide which multimedia objects are most appropriate for the presentation being made. “Continuous Slide” 1201 is initiated when the user chooses to add a multimedia object to “Continuous Slide” 1201.

The user obtains a list of multimedia objects either by clicking on the collections 902, or clicking on the search 901, FIG. 9. These multimedia objects can be added to the “Continuous Slide” 1201 by right clicking on the selected object and selecting the “Add to Continuous Slide” option. The object added by the user is added to the “Continuous Slide” object list sequentially. The user may add an unlimited number of objects, as the maximum number of allowable objects is unlimited. FIG. 12 illustrates the interface and the method of playing the selected multimedia objects in sequence after each other.

FIG. 12 displays all the multimedia objects 1203 added by the user. It also displays the total duration 1205 of each type of multimedia object along with the duration of each object 1204. The user can change the sequencing of the objects under an object group. “Continuous Slide” 1201 allows users to create a custom sequence wherein the user can choose to play a combination of animations and videos. The user can also choose to delete any object from the “Continuous Slide” 1201 object list. “Continuous Slide” player 1202 controls features such as stop, play, pause, next, previous and replay.

Continuous slide 1201 is an application designed using Visual Basic (VB.net). The application process starts from a click from the user, wherein the user selects the multimedia objects from the grid and clicks “Add to Continuous Slide” 1201 using the right click menu. The multimedia objects added by the user and its sequence are stored in an XML file. Multimedia object duration, name and other information are show by querying from the Meta object file.

Accordingly, it is intended that all matter contained in the above description and shown in the accompanying drawings be interpreted as illustrative of the inventive concept and not in a limiting sense.

What is claimed is:

1. A computer implemented system of creating a presentation, comprising:
a central repository of multimedia objects hosted on the internet;
a local repository of multimedia objects located on a user computer;
an update manager that can be instructed to update the multimedia content in the local repository by mirroring the content of said central repository when said user's computer is connected to said web service on the internet;
a download manager which initiates said update manager;
a presentation application that is used by the user as a template for preparing and presenting the presentation; and
a seamless presentation integrator, further comprising:
means for instantaneously correlating text inputs of a user to said multimedia objects and presenting in real time using a pop-up menu of relevant multimedia objects to the user, whereby the user can select the most relevant multimedia objects for insertion in the presentation application;
means for embedding the selected multimedia objects onto said presentation application; and
means for creating continuous multimedia presentation for continuously playing said multimedia objects in the presentation application.

2. A computer implemented method of creating a presentation, comprising:
creating a central repository of multimedia objects hosted on the internet;
updating the multimedia content in a local repository of a user's computer by mirroring the content of said central repository into said local repository when the user's computer is connected to said web service;
providing a presentation application that is used by the user as a template for preparing and presenting the presentation;
correlating text inputs of the user instantaneously to the multimedia objects in the local repository and presenting in real time using a pop-up menu, relevant multimedia objects to the user, whereby the user can select the most relevant multimedia objects for insertion in the presentation application;
embedding the selected multimedia objects on the presentation application; and
creating a continuous multimedia presentation of continuously playing selected multimedia objects in the presentation application.

3. The computer implemented method of creating a presentation of claim 2, wherein the multimedia objects include animations, movies, and diagrams.

4. The computer implemented method of creating a presentation of claim 2, wherein the user can add, preview and modify the multimedia objects.

5. The computer implemented method of creating a presentation of claim 2, wherein the user can disable the instant feature and search multimedia objects using a keyword search.

6. The computer implemented method of creating a presentation of claim 2, wherein the speed of playing the continuous multimedia presentation can be controlled through a continuous presentation slide player.

7. The computer implemented method of creating a presentation of claim 2, wherein a user can create new multimedia objects and add them to the local repository.

8. The computer implemented method of creating a presentation of claim 2, wherein the user can modify the sequence and duration of the continuously playing multimedia objects.
